(19) United States
(12) Patent Application Publication
(10) Pub. No.: US 2026/0277307 A1
(43) Pub. Date: Sep. 17, 2026

(54) MULTIMODAL-BASED HUMAN-COMPUTER INTERACTION METHOD AND SYSTEM THEREOF

(71) Applicant: GuangZhou Dazzle View Intelligent Technology Co., Ltd., Guangzhou (CN)

(72) Inventors: Zhiwen XIE, Guangzhou (CN); Zhixia CAI, Guangzhou (CN); Huiting HE, Guangzhou (CN)

(73) Assignee: GuangZhou Dazzle View Intelligent Technology Co., Ltd., Guangzhou (CN)

(21) Appl. No.: 19/565,866

(22) Filed: Mar. 13, 2026

(30) Foreign Application Priority Data
Mar. 13, 2025 (CN) 202510293143.4

(51) Int. Cl. G06F 3/01; G06V 40/16; G10L 15/22

(52) U.S. Cl. CPC G06F 3/011; G06V 40/171; G06V 40/174; G10L 15/22

(57) ABSTRACT

A voice feature, an environmental feature and a facial feature are respectively obtained based on receiving a user voice input, collecting environmental information and capturing a user facial expression. A pre-trained emotion recognition model is used to generate a user emotional feature, and meanwhile a pre-trained user behavior model is used to generate a behavior feature according to current operation information of the user. After obtaining the above features, respective first weights and second weights are dynamically adjusted and weighted feature fusion is performed to obtain a comprehensive feature. A plurality of candidate responses is generated based on the comprehensive feature, and a final response is selected by using a preset scoring mechanism and output the final response.

### CROSS-REFERENCE TO RELATED APPLICATIONS

This application claims priority to Chinese Patent Application No. 202510293143.4, filed on Mar. 13, 2025, the content of which is incorporated herein by reference in its entirety.

### TECHNICAL FIELD

The present disclosure relates to the technical field of human-computer interaction, and in particular, to a multimodal-based human-computer interaction method and system thereof.

### BACKGROUND

With the rapid development of artificial intelligence technology, human-computer interaction modes are gradually transforming from single physical interactions such as keyboards and mice to more natural and diverse interaction modes. The multimodal-based human-computer interaction methods have become a current research hotspot because they can comprehensively utilize multiple data sources such as sound, images, and environmental information to provide users with a richer and more accurate interaction experience.

Traditional human-computer interaction modes mainly rely on text input or physical key operations. Such modes are not only cumbersome but also fail to fully capture the user's emotional state and environmental changes, resulting in limited interaction experience.

Therefore, it is necessary to provide a multimodal-based human-computer interaction method and system thereof to solve the above technical problems.

### SUMMARY

To solve the above technical problems, the present disclosure provides a multimodal-based human-computer interaction method and system thereof. By comprehensively utilizing multiple data sources, comprehensive understanding of user intention and emotional state is realized, and the weights of each feature can be dynamically adjusted to generate a more intelligent and humanized interaction experience.

The present disclosure provides a multimodal-based human-computer interaction method, comprising:
receiving, a user voice input, collecting, environmental information, and capturing, the user facial expressions, by a feature acquisition device, and respectively obtaining a voice feature, an environmental feature, and a facial feature based on the voice input, the environmental information, and the facial expressions;
generating, by an emotional feature generation device, a user emotional feature based on the voice feature and the facial feature;
generating, by a behavior feature generation device, a behavior feature by using a pre-trained user behavior model according to user current operation information;
adjusting, by a comprehensive feature acquisition device, dynamically respective first weight and second weight based on representations of the voice feature, the environmental feature, the emotional feature, and the behavior feature, and performing, weighted feature fusion based on the first weight and the second weight to obtain a comprehensive feature, wherein the first weight is a feature importance weight for reflecting a relative importance degree of different features during interaction, and the second weight is an attention weight for adjusting an influence degree of different features during fusion; and
generating, by a response generation device, a plurality of candidate responses according to the comprehensive feature, screening the plurality of candidate responses by using a preset scoring mechanism to obtain a final response, and outputting the final response.

Preferably, receiving, a user voice input, collecting, environmental information, and capturing, the user facial expressions, by a feature acquisition device, and respectively obtaining a voice feature, an environmental feature, and a facial feature based on the voice input, the environmental information, and the facial expressions, comprises:
receiving, the user voice input via a voice receiving component, and extracting the voice feature via a voice signal processing method, wherein the voice feature comprises pitch, volume, speech rate, and voice content of a voice;
collecting, the environmental information, by using an environmental sensor, and extracting, the environmental feature via an environmental data analysis method; and
capturing, a user facial expression via a facial recognition camera component, analyzing, a facial image via an image processing method to identify and extract the facial feature, wherein the facial feature comprises an eye open/closed state, an eyebrow shape, a mouth opening degree, and an overall facial expression type.

Preferably, generating, by an emotional feature generation device, a user emotional feature based on the voice feature and the facial feature, comprises:
inputting, the extracted voice feature and facial feature into a pre-trained emotion recognition model, wherein the emotion recognition model is a convolutional neural network adopting a deep learning architecture and configured to capture an emotional cue in voice and facial expression;
performing, joint analysis on the input voice feature and facial feature by using the emotion recognition model, calculating and outputting, a probability distribution of user emotion category via trained weight and bias parameter, wherein the user emotion category comprises happiness, sadness, anger, surprise, fear, and neutrality; and
selecting, the user emotion category with the highest probability as the user current emotion according to the output probability distribution of the user emotion category, and generating, a user emotional feature vector, wherein the emotional feature vector comprises an emotion category.

Preferably, generating, by a behavior feature generation device, a behavior feature by using a pre-trained user behavior model according to user current operation information, comprises:
capturing and recording, the user current operation information in real time via a user operation monitoring component, and organizing, the user current operation information into a user operation sequence in chronological order, wherein the current operation information comprises an interaction history between the user and interaction element on an interface;
inputting, the user operation sequence into the pre-trained user behavior model, wherein the user behavior model is trained based on historical user behavior data and learned and understood an association between user operation and operation intention;
encoding and performing, feature extraction on the user operation sequence by using the user behavior model to generate a behavior feature vector, wherein the behavior feature vector comprises a feature element reflecting an operation intention.

Preferably, adjusting the first weight, comprises:
capturing and parsing, current representation data of the voice feature, the environmental feature, the emotional feature, and the behavior feature in real time, wherein the current representation data comprises a quantized value, a change rate of each feature, and a degree of association with a current interaction context;
calculating, an importance score of each feature in a current interaction scenario by using a statistical analysis method based on the current representation data of each feature; and
performing, weight allocation on the voice feature, the environmental feature, the emotional feature, and the behavior feature according to the calculated importance score to obtain the first weight of each feature, wherein the importance score is positively correlated with the first weight.

Preferably, adjusting the first weight, comprises:
capturing and recording, a response time of the user after receiving a voice instruction sent by an interaction device in real time, wherein the response time represents a response speed of the user to the current voice instruction;
calculating, an attention allocation degree of the user to each feature in the current interaction scenario by using an attention allocation model in combination with the response time; and
dynamically adjusting, the second weight of the voice feature, the environmental feature, the emotional feature, and the behavior feature according to the attention allocation degree, wherein the attention score is positively correlated with the second weight.

Preferably, the obtaining of the comprehensive feature, comprises:
constructing, a feature weight matrix and performing normalization processing according to the first weight and the second weight of each feature obtained through real-time adjustment, wherein a row of the feature weight matrix represents respective feature and a column represents the first weight or the second weight, and the feature weight matrix is:

$$W = [ \begin{matrix}{ω}_{11} & {ω}_{12} \\ {ω}_{21} & {ω}_{22} \\ {ω}_{31} & {ω}_{32} \\ {ω}_{41} & {ω}_{42}\end{matrix} ]$$

wherein ω11 and ω12 are respectively the first weight and the second weight of the voice feature,
ω21 and ω22 are respectively the first weight and the second weight of the environmental feature,
ω31 and ω32 are respectively the first weight and the second weight of the emotional feature,
ω41 and ω42 are respectively the first weight and the second weight of the behavior feature, and W is the feature weight matrix;
performing, weighting processing on each feature based on normalized feature weight matrix; and
fusing, weighted features by a feature concatenation method to generate a comprehensive feature vector.

Preferably, generating, by a response generation device, a plurality of candidate responses according to the comprehensive feature, screening the plurality of candidate responses by using a preset scoring mechanism to obtain a final response, and outputting the final response, comprises:
generating, the plurality of candidate responses by using a pre-trained response generation model based on the comprehensive feature vector;
calculating, a response emotional feature vector of each candidate response by using a pre-trained emotion analysis model;
performing, emotion similarity calculation between the response emotional feature vector of each candidate response and a user current emotional feature vector, wherein the emotion similarity is represented by a cosine similarity;
generating, an emotion matching score for each candidate response according to calculated emotion similarity; and
selecting, a candidate response with a highest score as a final response according to the emotion matching score and outputting the final response.

The present disclosure provides a multimodal-based human-computer interaction system, comprising:
a feature acquisition device, configured to receive, a user voice input, collect, environmental information, and capture, the user facial expressions, and respectively obtain a voice feature, an environmental feature, and a facial feature based on the voice input, the environmental information, and the facial expressions;
an emotional feature generation device, configured to generate, a user emotional feature based on the voice feature and the facial feature;
a behavior feature generation device, configured to generate, a behavior feature by using a pre-trained user behavior model according to user current operation information;
a comprehensive feature acquisition device, configured to adjust, dynamically respective first weight and second weight based on representations of the voice feature, the environmental feature, the emotional feature, and the behavior feature, and performing, weighted feature fusion based on the first weight and the second weight to obtain a comprehensive feature, wherein the first weight is a feature importance weight for reflecting a relative importance degree of different features during interaction, and the second weight is an attention weight for adjusting an influence degree of different features during fusion; and
a response generation device configured to generate, a plurality of candidate responses according to the comprehensive feature, screen the plurality of candidate responses by using a preset scoring mechanism to obtain a final response, and outputting the final response.

Compared with the related art, the multimodal-based human-computer interaction method and system thereof provided by the present disclosure have the following beneficial effects.

The present disclosure provides a multimodal-based human-computer interaction method and system thereof, relates to the technical field of human-computer interaction. A voice feature, an environmental feature and a facial feature are respectively obtained based on receiving a user voice input, collecting environmental information and capturing a user facial expression. A pre-trained emotion recognition model is used to generate a user emotional feature, and meanwhile a pre-trained user behavior model is used to generate a behavior feature according to current operation information of the user. After obtaining the above features, respective first weights and second weights are dynamically adjusted and weighted feature fusion is performed to obtain a comprehensive feature. Then a plurality of candidate responses is generated based on the comprehensive feature, and a final response is selected by using a preset scoring mechanism and output the final response. By comprehensively utilizing multiple data sources, a comprehensive understanding of the user's intention and emotional state is realized, and can dynamically adjust the weight of each feature, to generate a more intelligent and humanized interaction experience.

### BRIEF DESCRIPTION OF THE DRAWINGS

FIG. 1 is a flowchart of a multimodal-based human-computer interaction method provided by the present disclosure.

FIG. 2 is a method for obtaining a voice feature, an environmental feature, and a facial feature provided by the present disclosure.

FIG. 3 is a method for a user emotional feature based on the voice feature and the facial feature provided by the present disclosure.

FIG. 4 is a method for outputting the final response provided by the present disclosure.

FIG. 5 is a method for outputting the final response provided by the present disclosure.

FIG. 6 is a module diagram of a multimodal-based human-computer interaction system provided by the present disclosure.

### DETAILED DESCRIPTION OF THE EMBODIMENTS

The present disclosure will be described in further detail below with reference to the accompanying drawings and embodiments. It can be understood that the specific embodiments described herein are merely used to explain the present disclosure, rather than to limit the present disclosure. In addition, it should be noted that, for ease of description, only parts related to the present disclosure are shown in the accompanying drawings rather than the entire structure. Furthermore, the embodiments in the present disclosure and the features in the embodiments can be combined with each other if there is no conflict.

It should also be noted that, for ease of description, only parts related to the present disclosure are shown in the accompanying drawings rather than all content. Before discussing exemplary embodiments in more detail, it should be mentioned that some exemplary embodiments are described as processes or methods depicted as flowcharts. Although a flowchart describes operations (or steps) as sequential processing, many of the operations may be implemented in parallel, concurrently, or simultaneously. In addition, the order of the operations may be rearranged. The process may be terminated when its operations are completed, but may also have additional steps not included in the accompanying drawings. The process may correspond to a method, a function, a procedure, a subroutine, a subprogram, and the like.

### Embodiment 1

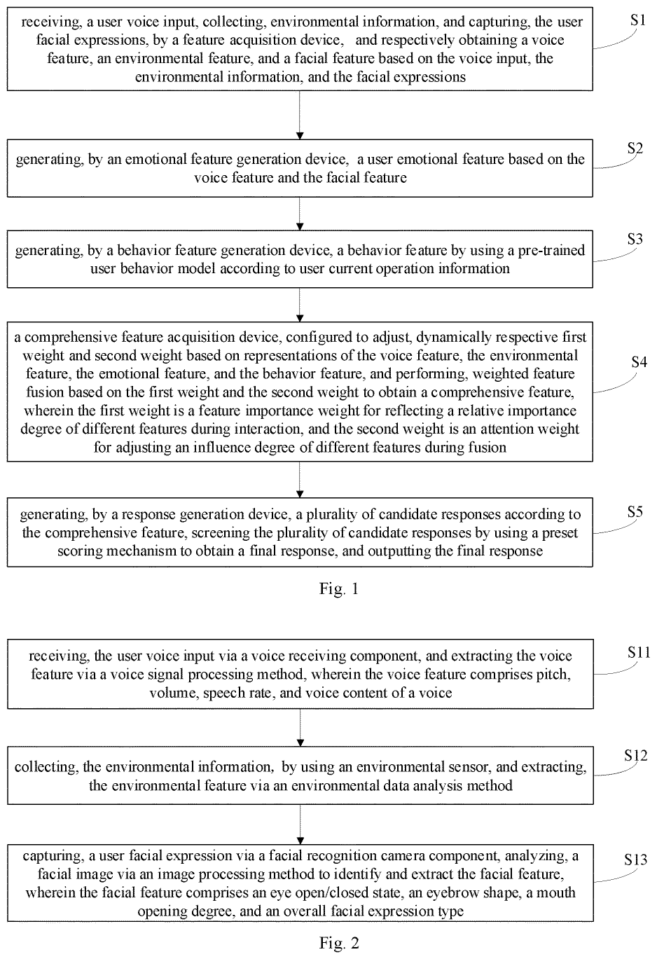

The present disclosure provides a multimodal-based human-computer interaction method. Reference to FIG. 1, the interaction method includes the following steps:

S1: receiving, a user voice input, collecting, environmental information, and capturing, the user facial expressions, by a feature acquisition device, and respectively obtaining a voice feature, an environmental feature, and a facial feature based on the voice input, the environmental information, and the facial expressions.

Specifically, Reference to FIG. 2, step S1 includes the following steps:

S11: receiving, the user voice input via a voice receiving component, and extracting the voice feature via a voice signal processing method, wherein the voice feature comprises pitch, volume, speech rate, and voice content of a voice.

In this embodiment, the voice receiving component may be, but is not limited to, a microphone array, configured to capture the user's voice input. The voice signal processing method mainly includes the following steps.

First, the captured voice signal is preprocessed, which includes denoising, noise reduction, and standardization processing, to remove environmental noise and improve signal quality.

A plurality of features is extracted from the preprocessed voice signal, and include pitch, volume, speech rate, and voice content. Pitch is extracted via spectrum analysis, volume via energy analysis, speech rate via duration analysis, and voice content is converted into text via Automatic Speech Recognition (ASR) technology.

The extracted various features are combined into a feature vector for subsequent processing and analysis.

These steps enable accurate capture and analysis of the user's voice features, providing reliable data support for subsequent emotion recognition and interaction. This method not only improves the accuracy of voice recognition, but also captures changes in the user's emotion, thereby enhancing the intelligent level of human-computer interaction.

S12: collecting, the environmental information, by using an environmental sensor, and extracting, the environmental feature via an environmental data analysis method.

In this embodiment, the environmental sensor includes a temperature sensor, a humidity sensor, a light sensor, and a sound sensor, configured to collect environmental information around the user. The environmental data analysis method mainly includes the following steps:
collecting environmental data in real time via various environmental sensors, including temperature, humidity, light intensity, and background noise;
preprocessing the collected environmental data, including filtering, smoothing, and standardization processing, so as to remove noise and abnormal values and improve data quality;
extracting a plurality of features from the preprocessed environmental data, including ambient temperature, humidity, light intensity, and background noise level. These features can reflect the current environmental conditions of the user.

The extracted various environmental features are combined into a feature vector via a feature concatenation method for subsequent processing and analysis.

These steps enable a comprehensive understanding of the user's environmental conditions, providing important background information for subsequent behavior analysis and emotion recognition. This method not only improves the environmental perception capability of the system, but also dynamically adjusts the interaction strategy according to environmental changes, thereby enhancing user experience.

S13: capturing, a user facial expression via a facial recognition camera component, analyzing, a facial image via an image processing method to identify and extract the facial feature, wherein the facial feature comprises an eye open/closed state, an eyebrow shape, a mouth opening degree, and an overall facial expression type.

In this embodiment, the facial recognition camera component may be, but is not limited to, a high-resolution camera, configured to capture the user's facial image. The image processing method mainly includes the following steps:

Collecting the user's facial image in real time via the camera to ensure the image is clear and unobstructed.

Preprocessing the collected facial image, including grayscale conversion, denoising, and standardization processing, so as to improve image quality and reduce noise interference.

Detecting and locate facial key points, including eyes, eyebrows, mouth, and other parts, using a face detection algorithm (Haar cascade classifier or deep learning model).

Extracting multiple facial features from the detected key points, including an eye open/closed state, an eyebrow shape, a mouth opening degree, and an overall facial expression type. These features can be extracted via analysis of geometric features and texture features.

Similarly, combine the extracted various facial features into a feature vector via a feature concatenation method for subsequent processing and analysis.

S2: generating, by an emotional feature generation device, a user emotional feature based on the voice feature and the facial feature.

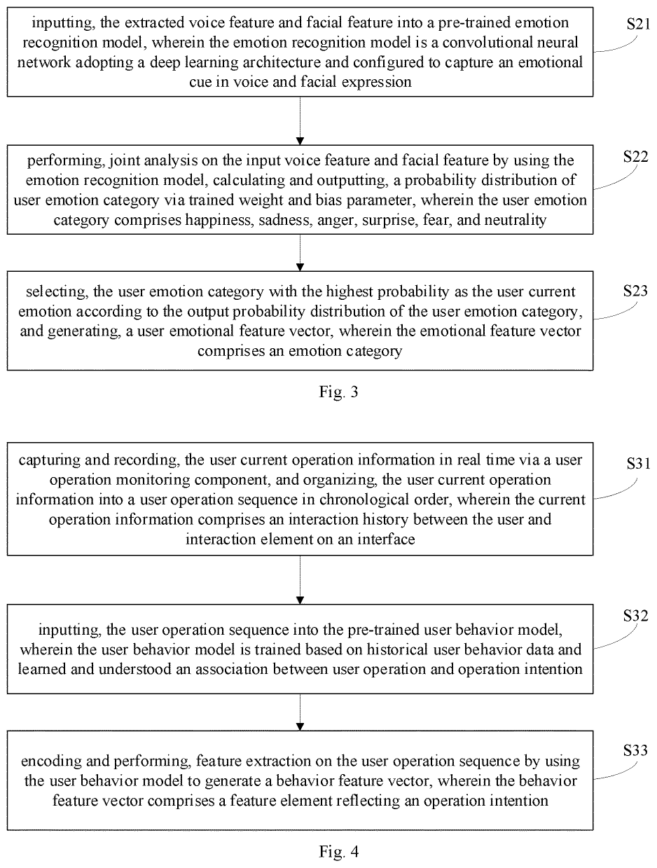

Specifically, Reference to FIG. 3, step S2 includes the following steps:

S21: inputting, the extracted voice feature and facial feature into a pre-trained emotion recognition model, wherein the emotion recognition model is a convolutional neural network adopting a deep learning architecture and configured to capture an emotional cue in voice and facial expression.

In this embodiment, the emotion recognition model is a deep learning-based Convolutional Neural Network (CNN), configured to capture emotional cues in voice and facial expressions. The specific working principle and process are as follows: The specific working principle and process are as follows.

The structure of the emotion recognition model includes:
an input layer, configured to receive feature vectors transmitted from the voice and facial feature extraction device;
a convolutional layer, configured to perform convolution operations on the input features via multiple convolution kernels to extract local features;
a pooling layer, configured to reduce feature dimension and retain main features via max-pooling or average-pooling operations;
a fully connected layer, configured to map the convolved and pooled features into a fixed-length vector for classification tasks; and
an output layer, configured to output a probability distribution of user emotion categories.

Input the features into the emotion recognition model, wherein the voice feature includes pitch, volume, speech rate, and voice content; the facial feature includes an eye open/closed state, an eyebrow shape, a mouth opening degree, and an overall facial expression type.

The feature vectors of the voice feature and the facial feature are spliced into one feature vector, and input it into the emotion recognition model. The model extracts emotional cues in the voice and facial features via multi-layer convolution and pooling operations.

S22: performing, joint analysis on the input voice feature and facial feature by using the emotion recognition model, calculating and outputting, a probability distribution of user emotion category via trained weight and bias parameter, wherein the user emotion category comprises happiness, sadness, anger, surprise, fear, and neutrality.

In this embodiment, the emotion recognition model performs joint analysis on the input voice feature and facial feature via trained weight and bias parameters, and calculates and outputs a probability distribution of user emotion categories. The specific working principle and process are as follows.

First, perform feature processing, specifically: splice the feature vectors of the voice feature and the facial feature into one feature vector, and normalize the feature vector to ensure feature values are within the same range.

Then, perform model inference, specifically: input the normalized feature vector into the emotion recognition model, extract high-level features via multi-layer convolution and pooling operations, use the ReLU activation function to increase the nonlinear capability of the model, map the extracted high-level features into a fixed-length vector for classification tasks, and convert the output of the fully connected layer into a probability distribution via the SoftMax function, representing the probability of each user emotion category.

Finally, output the probability distribution of user emotion categories, including probabilities of happiness, sadness, anger, surprise, fear, and neutrality.

S23: selecting, the user emotion category with the highest probability as the user current emotion according to the output probability distribution of the user emotion category, and generating, a user emotional feature vector, wherein the emotional feature vector comprises an emotion category.

In this embodiment, the user emotion category with the highest probability is selected as the current emotion of the user according to the probability distribution of user emotion categories output by the emotion recognition model, and the emotional feature vector of the user is generated. The specific working principle and process are as follows.

First, perform probability distribution analysis, specifically,

Obtaining, the probability distribution of user emotion categories from the output of the emotion recognition model, including probability values of happiness, sadness, anger, surprise, fear, and neutrality, and select the user emotion category with the highest probability as the current emotion of the user.

Then, perform emotional feature vector generation, specifically, the selected user emotion category is being taken as an emotional label, and generate an emotional feature vector containing the emotional label.

S3: generating, by a behavior feature generation device, a behavior feature by using a pre-trained user behavior model according to user current operation information.

Specifically, Reference to FIG. 4, step S3 includes the following steps:

S31: capturing and recording, the user current operation information in real time via a user operation monitoring component, and organizing, the user current operation information into a user operation sequence in chronological order, wherein the current operation information comprises an interaction history between the user and interaction element on an interface.

In this embodiment, the user operation monitoring component is configured to capture and record the current operation information of the user in real time. The specific working principle and process are as follows.

First, the user operation monitoring component may be, but is not limited to, input devices such as a touch screen, a mouse, and a keyboard, configured to capture the user's operation behaviors, and the operation information of the user is captured in real time via these input devices, including clicking, sliding, and text input.

Then, record the captured operation information, including a timestamp of the operation, an operation type (click, slide), and an operation position, and organize the operation information of the user into a user operation sequence in chronological order. Exemplarily, an operation sequence of the user on an interface may include: click Button A→slide the screen→input text→click Button B.

Finally, the user operation sequence contains the interaction history between the user and interaction elements on the interface, and such information can reflect the user's operation habits and intentions.

S32: inputting, the user operation sequence into the pre-trained user behavior model, wherein the user behavior model is trained based on historical user behavior data and learned and understood an association between user operation and operation intention.

In this embodiment, the user behavior model is a deep learning model trained based on historical user behavior data, configured to understand and predict user operation intentions. The specific working principle and process are as follows.

The structure of the user behavior model includes:
an input layer, configured to receive the user operation sequence as input;
an embedding layer, configured to convert information such as operation type and timestamp into fixed-length embedding vectors;
a Recurrent Neural Network (RNN), configured to model the user operation sequence via the RNN and capture temporal dependencies between operations;
a fully connected layer, configured to map the output of the RNN into a fixed-length vector for classification tasks; and
an output layer, configured to output a probability distribution or a feature vector of user operation intentions.

When constructing the user behavior model, a large amount of historical user behavior data is collected, including user operation sequences on the interface and corresponding operation intentions, and then the historical data is cleaned and preprocessed, including removing abnormal values and filling missing values. The user behavior model is trained using the historical user behavior data, and model parameters are optimized via a backpropagation algorithm, so that the model can accurately understand and predict user operation intentions.

A cross-entropy loss function is used to measure the difference between the predicted value and the true value of the model.

When processing by the user behavior model, the user operation sequence is input into the pre-trained user behavior model, and the user behavior model outputs a probability distribution or a feature vector of user operation intentions, which can be used for subsequent behavior analysis and emotion recognition.

S33: encoding and performing, feature extraction on the user operation sequence by using the user behavior model to generate a behavior feature vector, wherein the behavior feature vector comprises a feature element reflecting an operation intention.

In this embodiment, the user behavior model encodes and performs feature extraction on the user operation sequence to generate a behavior feature vector. The specific working principle and process are as follows.

Converting, each operation type and timestamp in the user operation sequence into a fixed-length embedding vector.

Modeling the user operation sequence temporally via the RNN to capture temporal dependencies between operations.

Mapping the output of the RNN into a fixed-length feature vector, wherein the feature vector includes feature elements reflecting operation intentions.

The generated behavior feature vector contains important features of the user operation sequence, which can reflect the user's operation intentions and habits. Each element in the feature vector represents a specific feature, such as operation frequency, operation type distribution, operation time interval, and the like.

S4: a comprehensive feature acquisition device, configured to adjust, dynamically respective first weight and second weight based on representations of the voice feature, the environmental feature, the emotional feature, and the behavior feature, and performing, weighted feature fusion based on the first weight and the second weight to obtain a comprehensive feature, wherein the first weight is a feature importance weight for reflecting a relative importance degree of different features during interaction, and the second weight is an attention weight for adjusting an influence degree of different features during fusion.

In step 4, adjusting the first weight, comprises:
capturing and parsing, current representation data of the voice feature, the environmental feature, the emotional feature, and the behavior feature in real time, wherein the current representation data comprises a quantized value, a change rate of each feature, and a degree of association with a current interaction context.

In this embodiment, real time capture and parsing of the user's current feature representation data form the basis for dynamically adjusting feature weights. The specific working principle and process are as follows.

The user's voice features, environmental features, facial features, and behavior features are captured in real time through the voice receiving component, environmental sensors, facial recognition camera component, and user operation monitoring component. The captured data is parsed to extract quantized values of each feature. For example: pitch, volume, speech rate, and voice content for voice features; temperature, humidity, light intensity, and background noise for environmental features; eye open/closed state, eyebrow shape, mouth opening degree, and overall expression type for facial features; and operation type, operation position, and timestamp for behavior features.

The calculation method for the change rate is as follows.

A time window is set, and the change rate of each feature within this time window is calculated. The change rate reflects the trend of feature variation over time.

The change rate of each feature is calculated using the difference method, with the difference formula as follows:

$$Δ F = \frac{F ( t ) - F ( t - Δ t )}{Δ t}$$

where ΔF is the change rate, F(t) is the feature value at the current time t, F(t−Δt) is the feature value at the previous time (t−Δt), and Δt is the time interval.

For example, for the pitch change rate ΔP of a voice feature at time t with a time interval Δt of 1 second, the calculation formula is:

$$Δ P = \frac{P ( t ) - P ( t - 1 )}{1}$$

where P(t) is the pitch at current time t, and P(t−1) is the pitch at previous time (t−1).

For the temperature change rate ΔT of an environmental feature at time t with a time interval Δt of 1 second, the calculation formula is:

$$Δ T = \frac{T ( t ) - T ( t - 1 )}{1}$$

where T(t) is the temperature at current time t, and T(t−1) is the temperature at previous time (t−1).

For the eye open/closed change rate ΔE of a facial feature at time t with a time interval Δt of 1 second, the calculation formula is:

$$Δ E = \frac{E ( t ) - E ( t - 1 )}{1}$$

where E(t) is the eye open/closed value at current time t, and E(t−1) is the eye open/closed value at previous time (t−1).

The degree of contextual relevance can be obtained through correlation analysis, which directly reflects the linear relationship between features. The details are as follows:

The quantized values and change rates of the captured features are organized into feature vectors, and the current interaction context information is defined, such as the user's current operation intention and emotional state.

The Pearson correlation coefficient between each feature and the current interaction context is calculated, with the formula for the Pearson correlation coefficient r as follows:

$$r = \frac{\sum ( {x}_{i} - \overline{x} ) ( {y}_{i} - \overline{y} )}{\sqrt{\sum {( {x}_{i} - \overline{x} )}^{2} \sum {( {y}_{i} - \overline{y} )}^{2}}}$$

where xᵢ is the feature value of each feature, yᵢ is the contextual information value, and x̅ and y̅ are the mean values of the feature values and contextual information values, respectively.

The calculated Pearson correlation coefficient is converted into a relevance score Q using the following formula:

$$Q = \vert r \vert$$

where the relevance score ranges from 0 to 1, and a higher value indicates stronger relevance.

Based on the current representation data of each feature, the importance score of each feature in the current interaction scenario is calculated using statistical analysis methods.

In this embodiment, the importance score of each feature is calculated using statistical analysis methods based on the captured current feature representation data. The specific working principle and process are as follows.

First, the quantized values, change rates, and relevance scores of the captured features are organized into feature vectors, which are then normalized to ensure all feature values fall within the same range and avoid bias caused by excessively large or small feature values.

Next, principal component analysis (PCA) is used to extract the principal components of each feature. PCA transforms a high dimensional feature space into a low dimensional one while retaining most of the original data information. The contribution rate of each feature in the principal components is then calculated; the contribution rate reflects the importance of the feature in the current interaction scenario and can be evaluated by the variance explanation ratio of the principal components.

A linear regression model is used to assess the influence of each feature on the current interaction context. The linear regression model can predict the user's emotional state, and the absolute values of the model coefficients for each feature are computed during training, where the absolute coefficient value reflects the feature's influence on the target variable.

Finally, the importance score of each feature is calculated by weighting the relevance score from correlation analysis, the contribution rate from PCA, and the absolute coefficient value from regression analysis. Weights can be assigned to each analysis result and adjusted according to actual requirements.

The importance score reflects the relative importance of each feature in the current interaction scenario. Initial weight assignment is performed based on the importance scores. The features with higher importance scores are assigned higher weights, and vice versa.

Weight assignment is performed on the voice features, environmental features, emotional features, and behavior features according to the calculated importance scores to obtain the first weight of each feature, where the importance score is positively correlated with the first weight.

In this embodiment, the first weight is generated by assigning weights to each feature based on the calculated importance scores. The specific working principle and process are as follows.

The calculated importance scores are sorted in descending order and normalized to ensure the sum of all scores is 1.

The normalized importance scores are linearly mapped to a weight interval (e.g., 0 to 1). Features with higher importance scores are assigned higher first weights, and vice versa.

Meanwhile, the first weight of each feature is dynamically adjusted according to the user's real time feature representation data. When the user's feature representation data changes, the importance scores are recalculated and the first weights are adjusted accordingly.

In addition, smoothing can be applied to the first weight to avoid drastic fluctuations, such as using the exponentially weighted moving average (EWMA) method.

In Step S4, the adjustment of the second weight includes:

capturing and recording, a response time of the user after receiving a voice instruction sent by an interaction device in real time, wherein the response time represents a response speed of the user to the current voice instruction.

In this embodiment, real time capture and recording of the user's response time after receiving a voice instruction from the interaction device form the basis for dynamically adjusting the second weight. The specific working principle and process are as follows.

A voice instruction is sent to the user via the interaction device, and the time interval from when the user receives the instruction to when the user responds is recorded. The response can be a voice reply, touchscreen operation, or any other form of interactive behavior.

The timestamp of the voice instruction and the timestamp of the user's response are recorded, and the user's response time is calculated as the interval between instruction issuance and user response. The response time reflects the user's response speed to the current voice instruction.

An attention allocation model is used, combined with the response time, to calculate the user's attention allocation degree for each feature in the current interaction scenario.

In this embodiment, the attention allocation model is used together with the user's response time to calculate the user's attention allocation degree for each feature in the current interaction scenario. The specific working principle and process are as follows.

The attention allocation model is a deep learning based model that dynamically adjusts the attention paid to different features according to the user's response time.

The input layer of the attention allocation model receives the user's response time data and other feature data (e.g., voice features, environmental features, emotional features, and behavior features).

The attention layer of the attention allocation model computes the attention weight of each feature via an attention mechanism. The attention weight reflects the user's attention degree to each feature in the current interaction scenario.

The user's response time and other feature data are organized into a feature vector and normalized to ensure all values fall within the same range and avoid bias caused by excessively large or small values.

The attention weight of each feature is calculated via the attention mechanism, the attention weight reflects the user's attention degree to each feature.

The second weight of the voice features, environmental features, emotional features, and behavior features is dynamically adjusted according to the attention allocation degree, where the attention score is positively correlated with the second weight.

In this embodiment, the second weight of each feature is dynamically adjusted according to the calculated attention allocation degree. The specific working principle and process are as follows.

The calculated attention scores are sorted in descending order and normalized to ensure the sum of all scores is 1.

The normalized attention scores are linearly mapped to a weight interval (e.g., 0 to 1). Features with higher attention scores are assigned higher second weights, and vice versa.

The second weight of each feature is dynamically adjusted according to the user's real time response time data. When the user's response time data changes, the attention scores are recalculated and the second weights are adjusted accordingly.

In addition, smoothing can be applied to the second weight to avoid drastic fluctuations, such as using the exponentially weighted moving average (EWMA) method.

In Step S4, the acquisition of the comprehensive feature includes:
constructing, a feature weight matrix and performing normalization processing according to the first weight and the second weight of each feature obtained through real-time adjustment, wherein a row of the feature weight matrix represents respective feature and a column represents the first weight or the second weight, and the feature weight matrix is:

$$W = [ \begin{matrix}{ω}_{11} & {ω}_{12} \\ {ω}_{21} & {ω}_{22} \\ {ω}_{31} & {ω}_{32} \\ {ω}_{41} & {ω}_{42}\end{matrix} ]$$

wherein ω11 and ω12 are respectively the first weight and the second weight of the voice feature,
ω21 and ω22 are respectively the first weight and the second weight of the environmental feature,
ω31 and ω32 are respectively the first weight and the second weight of the emotional feature,
ω41 and ω42 are respectively the first weight and the second weight of the behavior feature, and W is the feature weight matrix;
performing, weighting processing on each feature based on normalized feature weight matrix; and
fusing, weighted features by a feature concatenation method to generate a comprehensive feature vector.

S5: generating, by a response generation device, a plurality of candidate responses according to the comprehensive feature, screening the plurality of candidate responses by using a preset scoring mechanism to obtain a final response, and outputting the final response.

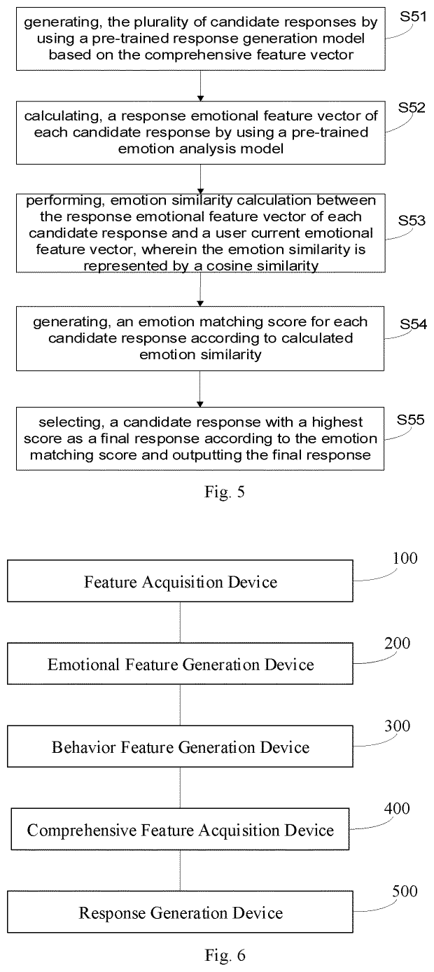

Specifically, Reference to FIG. 5, step S5 includes the following steps:

S51: generating, the plurality of candidate responses by using a pre-trained response generation model based on the comprehensive feature vector.

In this embodiment, the response generation model typically includes an input layer, an embedding layer, an encoding layer, a decoding layer, and an output layer. The input layer receives the comprehensive feature vector; the embedding layer converts features into embedding vectors; the encoding layer extracts high level features via an encoder; the decoding layer generates multiple candidate responses; and the output layer outputs the generated responses.

A large amount of historical dialogue data, including the user's comprehensive feature vectors and corresponding system responses, is collected, cleaned, and preprocessed. The response generation model is trained using the historical dialogue data, and model parameters are optimized via the backpropagation algorithm to enable the model to generate high quality responses. The cross entropy loss function is commonly used. The comprehensive feature vector is input into the pre trained response generation model, which outputs multiple candidate responses in text or other feedback forms.

S52: calculating, a response emotional feature vector of each candidate response by using a pre-trained emotion analysis model.

In this embodiment, the emotion analysis model is a deep learning based model used to recognize emotional features in text.

Historical text data with emotion labels is collected, cleaned, and preprocessed.

The emotion analysis model is trained using the labeled historical text data, and model parameters are optimized via the backpropagation algorithm to enable accurate emotion recognition in text. The cross entropy loss function is commonly used.

Each generated candidate response text is input into the pre trained emotion analysis model, which outputs an emotional feature vector for each candidate response containing the probability distribution of emotion categories.

S53: performing, emotion similarity calculation between the response emotional feature vector of each candidate response and a user current emotional feature vector, wherein the emotion similarity is represented by a cosine similarity.

In this embodiment, the user's emotional feature vector is generated in Step S23, and the candidate response emotional feature vector is generated in Step S52. Cosine similarity is used to compute the similarity between the two emotional feature vectors. An emotional similarity score is calculated for each candidate response, ranging from 0 to 1; a higher score indicates higher emotional similarity.

S54: generating, an emotion matching score for each candidate response according to calculated emotion similarity.

In this embodiment, the emotional similarity score of each candidate response calculated in Step S53 is normalized to ensure the sum of all scores is 1. The normalized emotional similarity score is used as the emotion matching score, which reflects the degree of matching between the candidate response and the user's current emotional state.

S55: selecting, a candidate response with a highest score as a final response according to the emotion matching score and outputting the final response.

In this embodiment, the emotion matching scores of all candidate responses are sorted in descending order. The candidate response with the highest emotion matching score is selected as the final response, which is formatted as system output and fed back to the user via voice, text, or other forms.

### Embodiment 2

The present disclosure further provides a multimodal based human computer interaction system for implementing the multimodal based human computer interaction method. As shown in FIG. 2, the interaction system includes:
a feature acquisition device 100, configured to receive, a user voice input, collect, environmental information, and capture, the user facial expressions, and respectively obtain a voice feature, an environmental feature, and a facial feature based on the voice input, the environmental information, and the facial expressions;
an emotional feature generation device 200, configured to generate, a user emotional feature based on the voice feature and the facial feature;
a behavior feature generation device 300, configured to generate, a behavior feature by using a pre-trained user behavior model according to user current operation information;
a comprehensive feature acquisition device 400, configured to adjust, dynamically respective first weight and second weight based on representations of the voice feature, the environmental feature, the emotional feature, and the behavior feature, and performing, weighted feature fusion based on the first weight and the second weight to obtain a comprehensive feature, wherein the first weight is a feature importance weight for reflecting a relative importance degree of different features during interaction, and the second weight is an attention weight for adjusting an influence degree of different features during fusion; and
a response generation device 500 configured to generate, a plurality of candidate responses according to the comprehensive feature, screen the plurality of candidate responses by using a preset scoring mechanism to obtain a final response, and outputting the final response.

This application is described with reference to flowcharts and/or block diagrams of methods, apparatuses (systems), and computer program products according to embodiments of the application. It shall be understood that each flow and/or block in the flowcharts and/or block diagrams, and combinations of flows and/or blocks in the flowcharts and/or block diagrams, can be implemented by computer program instructions. These computer program instructions may be provided to a processor of a general purpose computer, special purpose computer, embedded processor, or other programmable data processing apparatus to produce a machine, such that the instructions executed by the processor of the computer or other programmable data processing apparatus create means for implementing the functions specified in one or more flows of the flowcharts and/or one or more blocks of the block diagrams.

A person skilled in the art can understand that all or part of the steps in the methods of the above embodiments can be implemented by a program instructing relevant hardware. The program can be stored in a computer readable storage medium, including read only memory (ROM), random access memory (RAM), programmable read only memory (PROM), erasable programmable read only memory (EPROM), one time programmable read only memory (OTPROM), electrically erasable programmable read only memory (EEPROM), compact disc read only memory (CD ROM), or other optical disk storage, magnetic disk storage, tape storage, or any other medium that can carry or store data and be read by a computer.

It should also be noted that the terms “comprise,” “include,” or any other variation thereof are intended to cover a non-exclusive inclusion, such that a process, method, article, or apparatus that comprises a list of elements includes not only those elements but also other elements not expressly listed or inherent to such process, method, article, or apparatus. Without further limitation, an element defined by the phrase “comprising a . . . ” does not exclude the presence of additional identical elements in the process, method, article, or apparatus that comprises the element.

What is claimed is:

1. A multimodal-based human-computer interaction method, comprising:
receiving a user voice input, collecting environmental information, and capturing user facial expressions, and respectively obtaining a voice feature, an environmental feature, and a facial feature based on the voice input, the environmental information, and the facial expressions;
generating a user emotional feature based on the voice feature and the facial feature;
generating a behavior feature by using a pre-trained user behavior model according to user current operation information; and
adjusting dynamically respective first weight and second weight based on representations of the voice feature, the environmental feature, the emotional feature, and the behavior feature, and performing weighted feature fusion based on the first weight and the second weight to obtain a comprehensive feature, wherein the first weight is a feature importance weight for reflecting a relative importance degree of different features during interaction, and the second weight is an attention weight for adjusting an influence degree of different features during fusion;
wherein adjusting the first weight comprises:
calculating an importance score of each feature in a current interaction context by using a statistical analysis method based on current representation data of each feature captured in real time; calculating an importance rating of each feature in the current interaction context by using a statistical method, and performing weight allocation on each feature according to the importance rating to obtain the first weight of each feature positively correlated with the importance score, wherein the current representation data comprises a quantized value, a change rate of each feature, and a degree of association with the current interaction context;
wherein adjusting the second weight, comprises:
calculating an attention allocation degree of the user to each feature in the current interaction context by using an attention allocation model based on a real-time captured and recorded response time of the user after receiving a voice instruction sent by an interaction device, which is captured and recorded in real time, and dynamically adjusting the second weight of each feature positively correlated therewith according to the attention allocation degree;
generating a plurality of candidate responses according to the comprehensive feature, screening the plurality of candidate responses by using a preset scoring mechanism to obtain a final response, and outputting the final response.

2. The multimodal-based human-computer interaction method according to claim 1, wherein the receiving a user voice input, collecting environmental information, and capturing the user facial expressions, and respectively obtaining a voice feature, an environmental feature, and a facial feature based on the voice input, the environmental information, and the facial expressions comprises:
receiving the user voice input via a voice receiving component, and extracting the voice feature via a voice signal processing method, wherein the voice feature comprises pitch, volume, speech rate, and voice content of a voice;
collecting the environmental information by using an environmental sensor, and extracting the environmental feature via an environmental data analysis method; and
capturing a user facial expression via a facial recognition camera component, analyzing a facial image via an image processing method to identify and extract the facial feature, wherein the facial feature comprises an eye open/closed state, an eyebrow shape, a mouth opening degree, and an overall facial expression type.

3. The multimodal-based human-computer interaction method according to claim 2, wherein the generating a user emotional feature based on the voice feature and the facial feature comprises:
inputting the extracted voice feature and facial feature into a pre-trained emotion recognition model, wherein the emotion recognition model is a convolutional neural network adopting a deep learning architecture and configured to capture an emotional cue in voice and facial expression;
performing joint analysis on the input voice feature and facial feature by using the emotion recognition model, calculating and outputting, a probability distribution of user emotion category via trained weight and bias parameter, wherein the user emotion category comprises happiness, sadness, anger, surprise, fear, and neutrality; and
selecting the user emotion category with the highest probability as the user current emotion according to the output probability distribution of the user emotion category, and generating a user emotional feature vector, wherein the emotional feature vector comprises an emotion category.

4. The multimodal-based human-computer interaction method according to claim 3, wherein the generating a behavior feature by using a pre-trained user behavior model according to user current operation information comprises:
capturing and recording the user current operation information in real time via a user operation monitoring component, and organizing the user current operation information into a user operation sequence in chronological order, wherein the current operation information comprises an interaction history between the user and interaction element on an interface;
inputting the user operation sequence into the pre-trained user behavior model, wherein the user behavior model is trained based on historical user behavior data and learned and understood an association between user operation and operation intention;
encoding and performing feature extraction on the user operation sequence by using the user behavior model to generate a behavior feature vector, wherein the behavior feature vector comprises a feature element reflecting an operation intention.

5. The multimodal-based human-computer interaction method according to claim 4, wherein the obtaining the comprehensive feature comprises:
constructing a feature weight matrix and performing normalization processing according to the first weight and the second weight of each feature obtained through real-time adjustment, wherein a row of the feature weight matrix represents respective feature and a column represents the first weight or the second weight, and the feature weight matrix is:
$$W = [ \begin{matrix}{ω}_{11} & {ω}_{12} \\ {ω}_{21} & {ω}_{22} \\ {ω}_{31} & {ω}_{32} \\ {ω}_{41} & {ω}_{42}\end{matrix} ]$$
wherein ω₁₁ and ω₁₂ are respectively the first weight and the second weight of the voice feature, ω₂₁ and ω₂₂ are respectively the first weight and the second weight of the environmental feature, ω₃₁ and ω₃₂ are respectively the first weight and the second weight of the emotional feature, ω₄₁ and ω₄₂ are respectively the first weight and the second weight of the behavior feature, and W is the feature weight matrix;
performing weighting processing on each feature based on normalized feature weight matrix; and
fusing weighted features by a feature concatenation method to generate a comprehensive feature vector.

6. The multimodal-based human-computer interaction method according to claim 5, wherein the generating a plurality of candidate responses according to the comprehensive feature, screening the plurality of candidate responses by using a preset scoring mechanism to obtain a final response, and outputting the final response comprises:
generating the plurality of candidate responses by using a pre-trained response generation model based on the comprehensive feature vector;
calculating a response emotional feature vector of each candidate response by using a pre-trained emotion analysis model;
performing emotion similarity calculation between the response emotional feature vector of each candidate response and a user current emotional feature vector, wherein the emotion similarity is represented by a cosine similarity;
generating an emotion matching score for each candidate response according to calculated emotion similarity; and
selecting a candidate response with a highest score as a final response according to the emotion matching score and outputting the final response.
